(19) United States
(12) Patent Application Publication
(10) Pub. No.: US 2003/0208686 A1
(43) Pub. Date: Nov. 6, 2003

(54) Method of data protection

(76) Inventors: Damodar R. Thummalapally, Milpitas, CA (US); Narsing K. Vijayrao, Santa Clara, CA (US)

Correspondence Address: Darryl G. Walker, WALKER & SAKO, LLP, Suite 235, 300 South First Street, San Jose, CA, 95113, US

(21) Appl. No.: 10/139,481

(22) Filed: May 6, 2002

(51) Int. Cl. G06F 12/14

(52) U.S. Cl. 713/193

(57) ABSTRACT

A method of protecting data received on a client device while coupled to a network through a communication channel has been disclosed. A client device (130) may receive protected data through a communication channel (140). A user public key (320) and a user private key (410) may be received by the client device (130). When protected data is to be stored on permanent storage (640), a link to a hidden file (220) may be generated using a random number generator. The link may be encrypted using user public key (320) to generate an encrypted link. Protected data may be stored in hidden file (220) and the encrypted link may be stored in a shield file (210). When the protected data is read from permanent storage (640), the encrypted link may be decrypted using user private key (410) to generate the link identifying hidden file (220). User private key (410) may not be stored on permanent storage (640). In this way, protected data may be provided with security and unauthorized use and/or theft of protected data may be reduced.

### TECHNICAL FIELD

The present invention relates generally to a method of data protection and more particularly to method of protecting data from a server system that may be accessed by a client.

### BACKGROUND OF THE INVENTION

Sensitive company information can be electronically transferred to data storage devices, such as a portable device, and stolen or misused. For example, a company may have an internal network of computers with each computer capable of accessing company data and transferring the data to various electronic media. The data may then be taken out of the company via transportable electronic media.

Typically, important company data may be stored on a mass storage device connected to a server. An employee, for example, may have a personal computer or workstation connected to the server. The employee may transfer the data to a storage medium attached to his workstation, personal computer, or a laptop, etc. The employee may then do as he pleases with this company information, such as transfer it to a transportable electronic media and take it home with him.

Also, a company may have users working at a remote location and accessing company data via remote access, such as an Internet connection, as just one example. These users may transfer company data to a remote storage device, such as a portable device. This data may be stolen or misused.

In view of the above discussion, it would be desirable to provide a security system that may allow company data to be protected when data is stored in a device that may be used to transport corporate data out of the network.

### SUMMARY OF THE INVENTION

According to the present embodiments, a method of protecting data received on a client device while coupled to a network through a communication channel has been disclosed. A client device may receive protected data through a communication channel. The client device may receive a first key (e.g., a user public key) and a second key (e.g., a user private key). A link may identify a hidden file. Such a link may be encrypted using a first key to generate an encrypted link. An encrypted link may be stored in a shield file.

According to one aspect of the embodiments, when the protected data is read from permanent storage, an encrypted link may be decrypted using a second key to generate the link identifying the hidden file.

According to another aspect of the embodiments, a second key may not be stored on permanent storage. In this way, protected data may be provided with security and unauthorized use and/or theft of protected data may be reduced.

According to another aspect of the embodiments, when protected data is to be stored on permanent storage, a link to a hidden file may be generated using a random number generator.

According to one aspect of the embodiments, a method of data protection may include the steps of receiving a first key and a second key, receiving protected data, and encrypting a link identifying a hidden file using the first key to generate a first encrypted link and storing the first encrypted link in a shield file.

According to another aspect of the embodiments, a method of data protection may include storing the first encrypted link in the shield file on a client device.

According to another aspect of the embodiments, a client device may include a personal computer, a laptop computer, a workstation, an essentially permanent data backup device, or a personal digital assistant, as just a few examples.

According to another aspect of the embodiments, the shield file and the hidden file may be stored on an essentially permanent storage device.

According to another aspect of the embodiments, a method of data protection may include the step of decrypting the first encrypted link to provide the link.

According to another aspect of the embodiments, the first key and the second key may be received from a network.

According to another aspect of the embodiments, the method of data protection may include writing at least a portion of the protected data to the hidden file.

According to another aspect of the embodiments, the method of data protection may include decrypting the first encrypted link using the second key to provide the link and reading the at least a portion of the protected data from the hidden file.

According to another aspect of the invention, a shield file may include encryption data. The encryption data may indicate a type of encryption of data in the hidden file.

According to another aspect of the invention, a shield file may include owner identifying data.

According to another aspect of the invention, a shield file may include scrambling data. The scrambling data may indicate a type of scrambling of data in the hidden file.

According to another aspect of the embodiments, the method of data protection may include the steps of receiving a first recovery key and a second recovery key and encrypting the link identifying the hidden file using the first recovery key to generate a first encrypted recovery link and storing the first encrypted recovery link in the shield file.

According to another aspect of the embodiments, the method of data protection may further include the step of decrypting the first encrypted recovery link using the second key to generate the link and reading the at least a portion of the protected data from the hidden file.

According to another aspect of the embodiments, the first key and the second key may be received on a client device and the second key may not be stored on an essentially permanent storage on the client device.

According to another aspect of the embodiments, a method of protecting data received on a client device while coupled to a network through a communication channel may include the steps of receiving a first and a second key at the client device, receiving protected data at the client device, encrypting a link identifying a hidden file using the first key to generate a first encrypted link and storing the first encrypted link in a shield file on an essentially permanent storage medium.

According to another aspect of the embodiments, the method of protecting data may include the step of writing at least a portion of the protected data to the hidden file on the essentially permanent storage medium.

According to another aspect of the embodiments, the hidden file may include a hidden metadata file and a hidden data file and at least one pointer to the hidden data file may be included in the hidden metadata file and at least a portion of the protected data is written to the hidden data file on the essentially permanent storage medium.

According to another aspect of the embodiments, the method of protecting data may include the step of scrambling the at least a portion of the protected data written to the hidden data file on the essentially permanent storage medium.

According to another aspect of the embodiments, the method of protecting data may include the steps of decrypting the first encrypted link using the second key to provide the link and reading the at least a portion of the protected data from the hidden file.

According to another aspect of the embodiments, the first and the second key are received on the client device from the network through the communication channel.

According to another aspect of the embodiments, the second key may not be stored on the essentially permanent storage medium.

### BRIEF DESCRIPTION OF THE DRAWINGS

FIG. 1 is block diagram of a network system in which a data protection system may be used according to one embodiment.

FIG. 2 is a block diagram illustrating components when a protected file is to be stored according to an embodiment.

FIG. 3 is a block diagram illustrating a method of encrypted metadata generation according to an embodiment.

FIG. 4 is a block diagram illustrating a method of decrypted metadata generation according to an embodiment.

FIG. 5 is a block diagram illustrating a method of decrypted metadata generation in a recover operation according to an embodiment.

FIG. 6 is a block diagram illustrating components of a computer system according to an embodiment.

FIG. 7 is a block diagram illustrating access to an unprotected or non-hidden file according to an embodiment.

FIG. 8(a) is a block diagram illustrating a first access request to a protected or hidden file according to an embodiment.

FIG. 8(b) is a block diagram illustrating access to a hidden file after shield file information has been accessed according to an embodiment.

### DETAILED DESCRIPTION OF THE EMBODIMENTS

Various embodiments of the present invention will now be described in detail with reference to a number of drawings.

Referring now to FIG. 1, a network system 100 in which a data protection system of the present invention may be used is set forth in a block schematic diagram according to an embodiment.

Network system 100 may include a mass storage system 110, a network server 120, a client device 130, and a communication channel 140.

A user may log onto a network system 100 from a client device 130. A user may use a device such as a smart card or chip card to provide such information, as just a few examples. A username and password may be sent from client device 130 to network server 120 through a communication channel 120. Network server 120 may authenticate a user based on a user network database. If a user is properly authenticated, network server 120 may provide client device 130 with a User Public Key (UPUK_S), a User Private Key (UPRK_S), a Recovery Public Key (URPUK_S), and a Recovery Private Key (URPRK_S). Network server 120 may also provide owner information and key expiration periods, to name just a few examples. After doing so, client device 130 may access data from, for example, mass storage 110. It should be noted that private keys (User Private Key and Recovery Private Key) may be stored in secured main memory, such as secured cache, of the client device 130 and may be prevented from being stored at another location. In this way, a user access to such keys may be limited.

Client device 130 may access data from mass storage 110 through communication channel 140. Network server 120 may receive the information request from client device 130 and may allow access to data from mass storage 110. Data accessed from mass storage 110 may include files that have been designated to be protected. If data is designated to be protected, it may be tagged as a protected file. Data accessed from mass storage 110 may also include files that have not been designated to be protected. If data is not designated to be protected, it may either be untagged or tagged as unprotected.

A communication channel 140 may take various forms for enabling communication between a sever (e.g., network server 120) and a client (e.g., remove device 130). As but a few of the many possible examples, a communication channel 140 may include the Internet, a wide area network (WAN), and/or a local area network (LAN).

When a client device 130 receives unprotected data, this data may be saved to permanent storage of client device 130. However, if client device 130 receives protected data, a method of protecting the data may be executed when saving the data to permanent storage.

In this way, data received from one location, such as a network server or the like, may be saved as protected data at another location, such as a client device. While client devices may take numerous forms, client device can include without limitation, home personal computers (PCs), laptop and/or notebook PCs, “handheld” devices such as personal digital assistants (PDAs) or the like, removable storage media such as conventional backup devices, and/or devices on a separate network. As but one very particular example, in the case of a partnership between corporations, protected data may be received from “host” corporate network and stored as protected data on a different “client” corporate network.

It is also noted that the above approach may differ from conventional encryption approaches in which data is encrypted on a machine according to only “local” criteria. That is, a user has essentially permanent control over one or more keys, and encrypts files according to such keys. According to the present invention, an entity other than a local user (e.g., a corporation or other business) may control access and lifetime of data received by a client user.

It is further noted that a client (e.g., a client device 130) should not be construed as being limited to one particular user. For example, multiple clients may reside on a client device 130. File transfers between such multiple users may be allowed or not according to a predetermined policy at a server (e.g., network server 120).

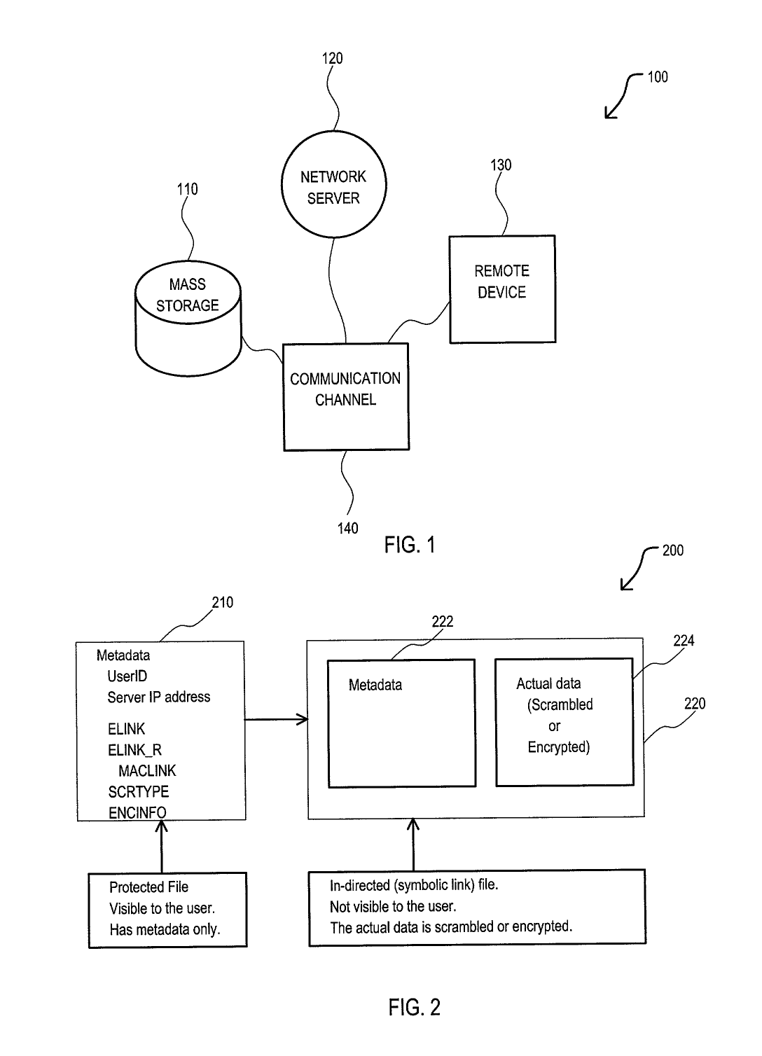

When protected data is stored to a permanent storage at a client device 130 a shield file and a hidden file or files may be created. FIG. 2 is a block schematic diagram illustrating components when a protected file is to be stored according to an embodiment.

Referring now to FIG. 2, when protected data is to be stored, a shield file 210 and hidden data files 220 may be created.

Shield file 210 may include shield metadata such as an encrypted link ELINK, an encrypted recovery link ELINK_R, a message authentication code MACLINK, a scramble type SCRTYPE, and encryption information ENCINFO. A shield metadata may also include ownership identifiers, such as a user identification and server Internet Protocol (IP) address, just to name a few. Hidden files 220 may include a hidden meta data file 222 and actual data file 224. Actual data file 224 may be scrambled or encrypted in accordance with scramble type SCRTYPE or encryption information ENCINFO.

A user of client device 130 may view shield file 210. However, hidden files 220 may be invisible to a user. When a user, whether directly or through a program, addresses a file name which has protected data, a name identifying a shield file 210 may be used. If a user has permission, shield file may use encrypted link ELINK and decryption techniques to generate a link LINK that may identify a hidden metadata file 222. Hidden metadata file 222 may then contain identifiers or pointers that may point to locations in which data file 224 may be stored. However, if a user does not have permission, link LINK may not be properly generated and hidden metadata file 220 may not be identified. In this case, user may receive a “file not found” message or “permission denied”, as just a few examples.

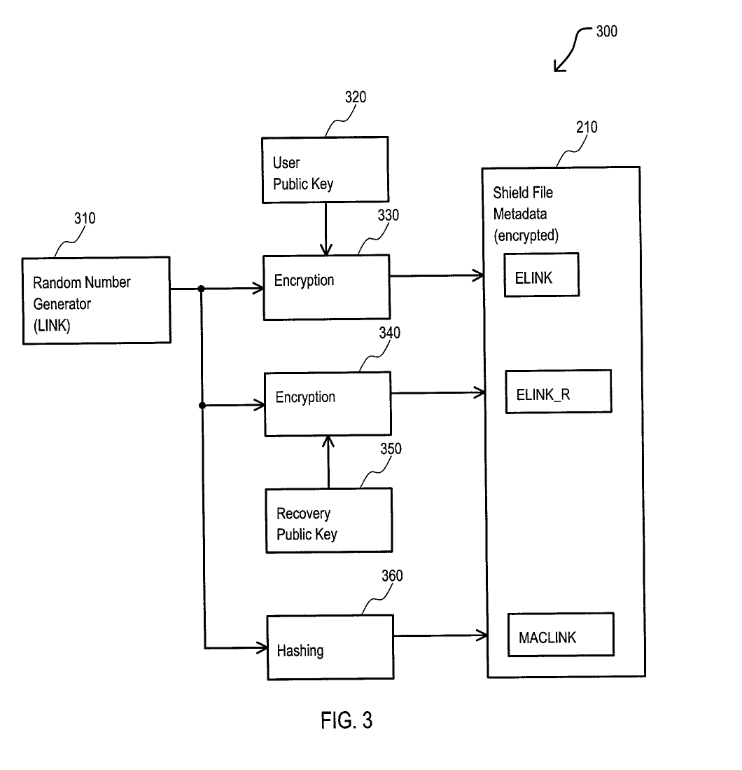

Referring now to FIG. 3, a block schematic diagram illustrating a method of encrypted metadata generation is set forth according to an embodiment and given the general reference character 300.

Encrypted metadata may be generated in response to actions that can generate conventional metadata. Typically, such operations arise in the generation of a “derivative” file. That is, a second file generated from a first file. Such derivative files may be created in response to numerous possible operations. A few of the many possible operations can be a “save as” operation, in which a file is saved under another name, a “rename” operation, in which a file name may be changed, cut and paste operations in which all or a portion of one file may be copied to another file, a “move” operation, in which a file may be moved from one location to another, consolidation and/or compression operations that may be group predetermined files together and/or compress such files, and append operations that update information of a file and/or metadata for a file.

Accordingly, files derived from protected files may be also become protected files.

When encrypted metadata is to be generated, a random number generator 310 may generate a random number to be used as a link LINK. Link LINK may be an identifier of hidden metadata file 222. Link LINK may then be encrypted according to an encryption step 330 using the User Public Key 320 to provide encrypted link ELINK. Also, link LINK may then be encrypted according to an encryption step 330 using the Recovery Public Key 350 to provide encrypted recovery link ELINK_R. Encrypted link ELINK and encrypted recovery link ELINK_R may be stored in shield file 210. A hashing step 360 may be performed on link LINK to provide message authentication code MACLINK.

In this way, a shield file 210 may be used to provide protection of data that an entity may wish to be protected. A user of a client device 130 may access information from shield file 210. However, because any link to hidden files 220 have been encrypted as encrypted link ELINK and encrypted recovery link ELINK_R, a user may not properly access protected data without proper permission.

Also, other metadata to be stored in the shield file, such as a User ID and Server IP Address, may be encrypted according to encryption step 330 using the Recovery Public Key 350 to provide other encrypted metadata in shield file 210. User ID and Server IP Address may be used to provide a way of allowing multiple clients to use a data protection method according to the present invention.

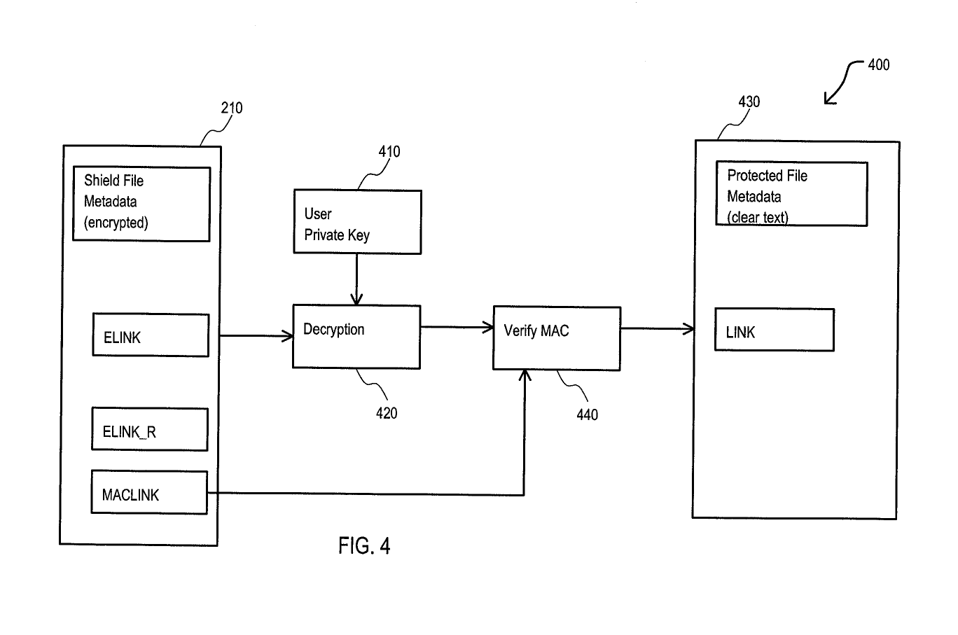

When a user wishes to access protected data stored at client device 130, shield file 210 may be accessed and according to whether or not a user has permission, hidden data files 220 may be accessed. The process for locating hidden data files 220 will now be discussed with reference to FIG. 4.

Referring now to FIG. 4, a block schematic diagram illustrating a method of decrypted metadata generation is set forth according to an embodiment and given the general reference character 400.

When a protected file is accessed, a user accesses shield file 210. Encrypted Link ELINK within shield file 210 may be decrypted according to a decryption step 420 using the User Private Key 410 to provide link LINK. Also, other encrypted metadata information, such as a User ID and Server IP Address may be decrypted according to a decryption step 420 using the User Private Key 410 to provide unencrypted or clear text meta data. A verify MAC step 440 may be used as a verification step that the correct user private key 410 was used. In verify MAC step 440, hashing may be performed on link LINK provided by decryption 420. If the result of hashing step matches with message authentication code MACLINK, then hidden metadata file 222 may be accessed. If there is no match, then a “file not found” message may be displayed to the user. In this way, a file may not be incorrectly accessed in the event a bad link is provided that matches another file.

With link LINK, hidden metadata file 222 (FIG. 2) may be accessed. Hidden metadata file 222 may provide the proper pointers to access hidden data file 234. In this way, hidden files 220 including protected data stored on a client device 130 may be accessed.

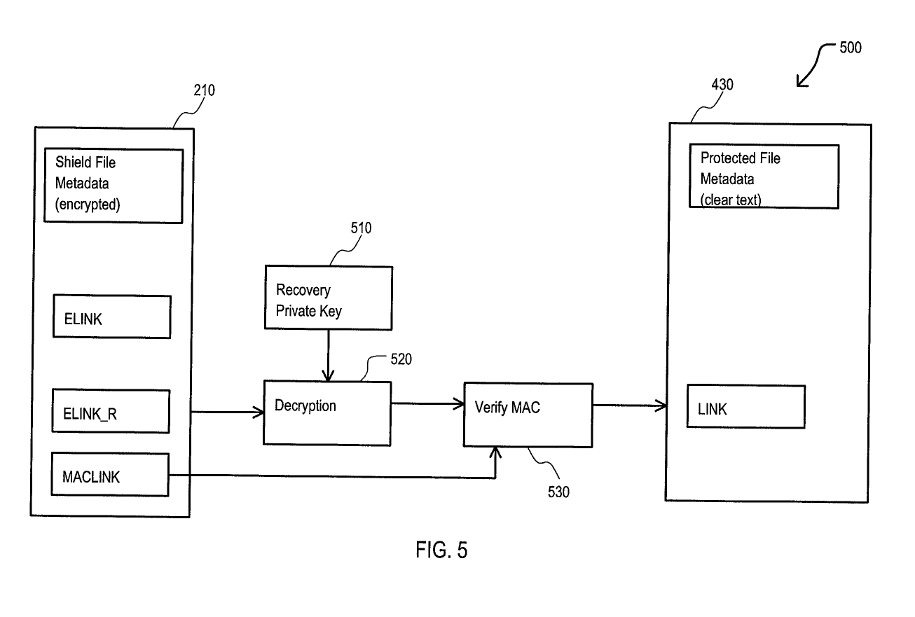

In some situations, a user of a client device 130 may have protected data stored on permanent storage at the client device 130. However, the user is no longer available or cooperative and the owner of the protected data may desire to access this information. In this case, a recovery operation may be used to access the hidden data files 220. The process for locating hidden data files 220 through a recover operation will now be discussed with reference to FIG. 5.

Referring now to FIG. 5, a block schematic diagram illustrating a method of decrypted metadata generation in a recover operation is set forth according to an embodiment and given the general reference character 500.

When a protected file is recovered, a user may access shield file 210. Encrypted Recovery Link ELINK_R within shield file 210 may be decrypted according to a decryption step 420 using the User Recovery Key 510 to provide link LINK. Also, other encrypted metadata information, such as a User ID and Server IP Address may be decrypted according to a decryption step 420 using the User Recovery Key 510 to provide unencrypted or clear text meta data. A verify MAC step 530 may be used as a verification step that the correct user private key 410 was used. In verify MAC step 530, hashing may be performed on link LINK provided by decryption 520. If the result of hashing step matches with message authentication code MACLINK, then hidden metadata file 222 may be accessed. If there is no match, then a “file not found” message may be displayed to the user. In this way, a file may not be incorrectly accessed in the event a bad link is provided that matches another file.

With link LINK, hidden metadata file 222 (FIG. 2) may be accessed. Hidden metadata file 222 may provide the proper pointers to access hidden data file 234. In this way, hidden files 220 including protected data stored on a client device 130 may be accessed.

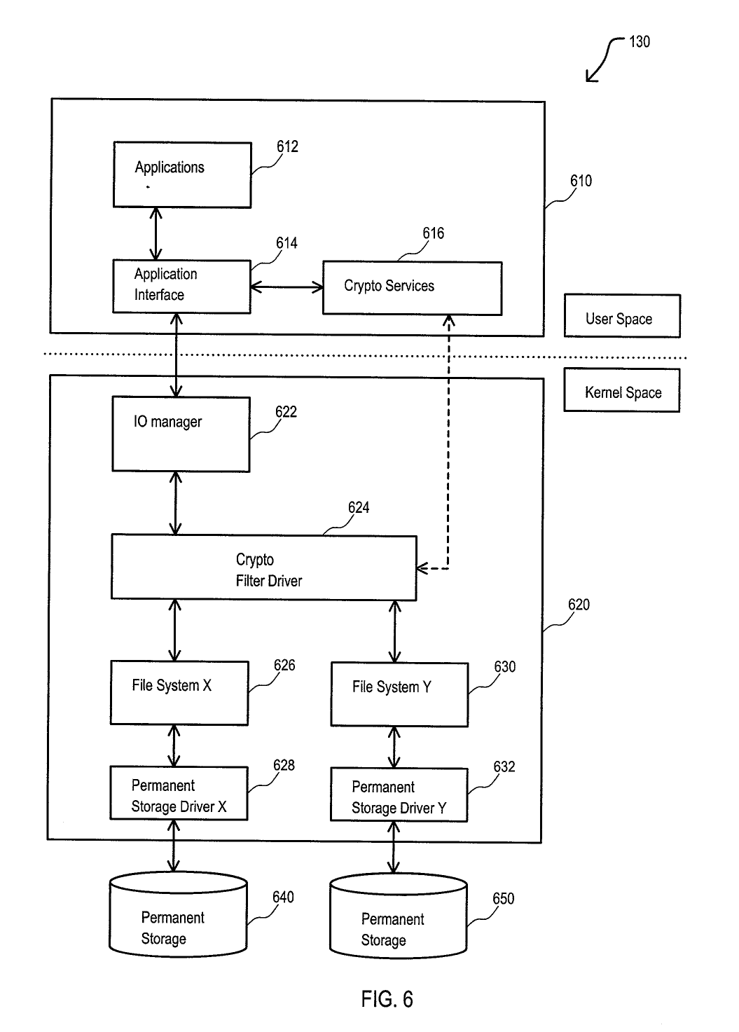

Referring now to FIG. 6, a block schematic diagram illustrating components of a computer system according to an embodiment is set forth.

Client device may include user space 610, kernel space 620, a “permanent” storage X 640 and a permanent storage Y 650.

User space 610 may be memory space dynamically allocated for application processes as needed. Kernel space 620 may be memory space and/or a set of input/output (I/O) ranges that may be restricted for use by an operating system.

User space 610 may include an application 612, an application interface 612, and crypto services 616. Application 612 may be any application, such as a word processor or computer aided design tool, to name just a few examples. An application interface 614 may provide a translation for request and/or responses in an application format to a format that may be used by an operating system, and vice-versa. Crypto services 616 may provide and/or verify user authentication. Crypto services 616 may receive information from a network server 120 (FIG. 1) (such information may include public keys and private keys) and may provide such information, thus permitting a verified user to read or write protected data from or to permanent storage 650 or a permanent storage Y 650.

Kernel space 620 may include an Input/Output (I/O) manager 622, a crypto filter driver 624, a file system X 626, a storage driver X 628, a file system Y 630, and a storage driver Y 632. I/O manager 622 may receive a request and/or response from application interface 614 and may direct the request and/or response to the appropriate driver, in this case, in a read or write request from permanent storage X 640, I/O manager 622 may direct the request to crypto filter driver 624. Crypto filter driver 624 may provide encryption (a write) or decryption (a read) if a file is a protected file. Crypto filter driver 624 may also provide scrambling/descrambling and/or encryption/decryption of hidden data file 224. However, if a file is an unprotected file, clear text, for example may be passed through unaffected by crypto filter driver 624. Crypto filter driver 624 may then pass the data to the file system X 626. File system X 626 may manage storage of files on secondary devices. Permanent storage driver 628 may manage access to storage medium.

It should be noted that the same general procedure may be followed in a read or write request with regard to permanent storage Y 650.

A permanent storage (640 and 650) may be storage that is essentially controlled by a user, such as a client. Thus, a permanent storage (640 and 650) may be conceptualized as a storage that is “detached” from a local operating system or the like. Permanent storage (640 and 650) may take various forms. As but a few of the many possible examples, a permanent storage (640 and 650) may be attached to a client machine, and hence may include magnetic or other nonvolatile storage media. In addition or alternatively, a permanent storage (640 and 650) may be attached essentially directly to a network, such as a network attached storage (NAS) device, or the like.

As illustrated in FIG. 1, a user of a client device 130 may log into a network system 100. Network server 120 may have a database which may be used to verify user before sending user public key, user private key, recovery public key, and recovery private key to client device 130. Crypto services 616, as illustrated in FIG. 6 may provide the verification information to the network server 120 and receive the keys and any other information related to the protection scheme, etc that may be necessary.

An application 612 may request data from (read) or send data to (write) permanent storage (640 and 650).

When protected data is written to permanent storage (640 and 650) from an application 612, crypto services 616 may verify that a user is a valid user that has clearance to save protected data to permanent storage (640 and 650). If so, crypto filter driver 624 may use the user public key to generate a shield file 210, as illustrated in FIG. 3. Crypto filter driver 624 may also provide encryption of protected data to be written into hidden files 220 in accordance with encryption information (ENCINFO). Likewise, crypto filter driver 624 may also provide scrambling of protected data to be written into hidden files 220 in accordance with scrambling type (SCRTYPE). In this way, protected data may be written into hidden files 220 with information identifying hidden files 220 being stored in shield file 210.

When protected data is read from permanent storage (640 and 650), crypto services 616 may verify that a user is a valid user that has clearance to read protected data from permanent storage (640 and 650). If so, crypto filter driver 624 may use the user private key to decrypt information from shield file 210, as illustrated in FIG. 3. Crypto filter driver 624 may also provide decryption of protected data read from hidden files 220 in accordance with encryption information (ENCINFO). Likewise, crypto filter driver 624 may also provide descrambling of protected data read from hidden files 220 in accordance with scrambling type (SCRTYPE). In this way, hidden files 220 may be identified and may be read from permanent storage (640 and 650).

By providing scrambling or encryption to data written to hidden files 220, protected data may be further protected. For example, in this case, if a binary reader is used to view data on permanent storage (640 and 650), protected data may not be easily deciphered.

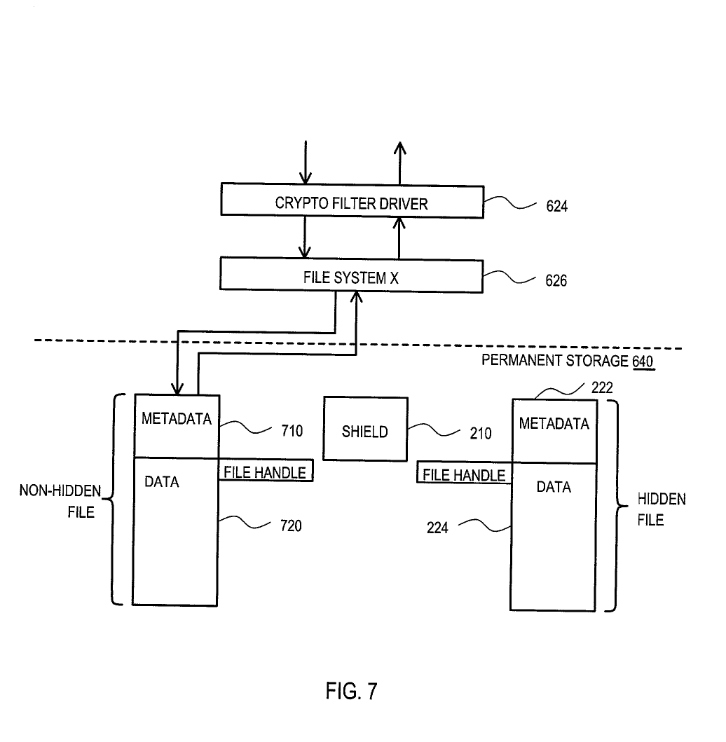

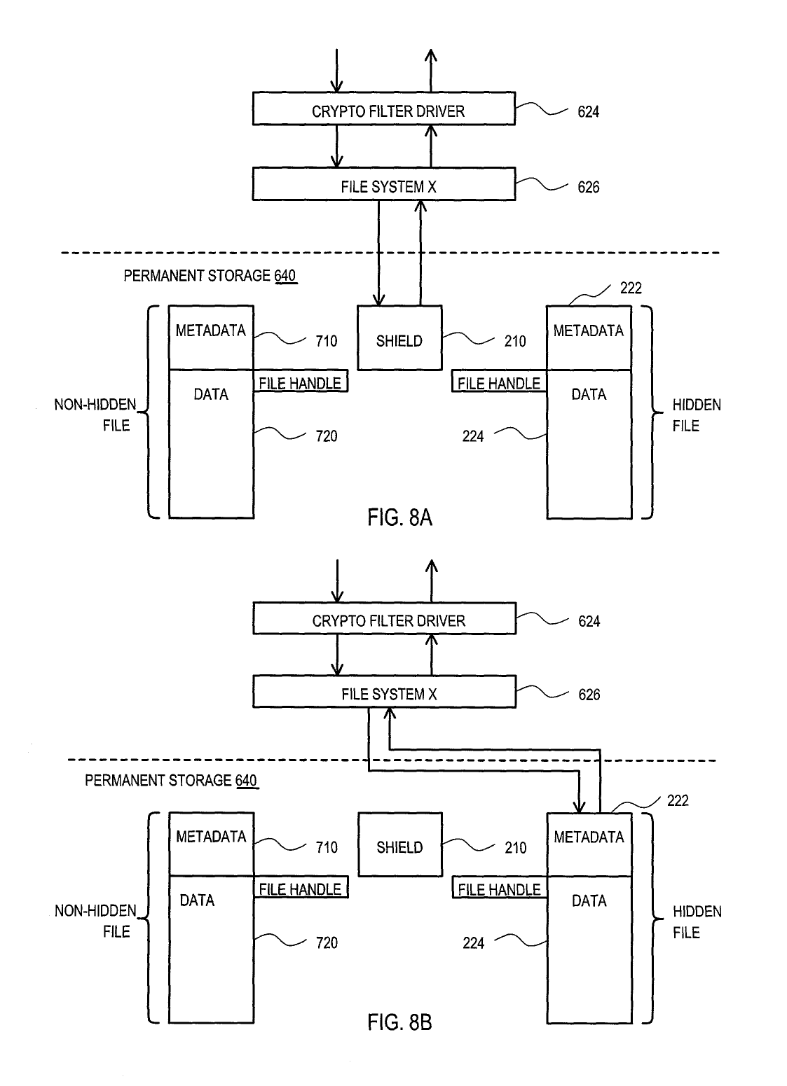

After a “first access” to a protected file, an encryption/decryption step of a link LINK may be skipped on subsequent accesses. In this case, a file system (626 or 630) may return a “file handle”. A file handle may identify actual data in a hidden file 224. An example of accesses to protected files and unprotected files will now be illustrated with reference to FIGS. 7 and 8.

Referring now to FIG. 7, a block diagram illustrating access to an unprotected or non-hidden file according to an embodiment is set forth. FIG. 7 illustrates a case where an unprotected file is accessed from permanent storage X 640.

When a non-hidden file is accessed, crypto filter driver 624 may detect the requested file is not protected. File system X 626 may access metadata 710 for the non-hidden file from permanent storage X 640. File system X 626 may then return a file handle identifying data 720 of non-hidden file. The file handle may then be given to the requesting process and used in further accesses.

Referring now to FIG. 8(a), a block diagram illustrating a first access request to a protected or hidden file according to an embodiment is set forth.

When a protected file is first accessed, crypto filter driver 624 may detect the requested file is “tagged” as protected. Crypto filter driver 624 may send shield file information to file system X 626. File system X 626 may access shield file 210 from permanent storage X 640 and return information to crypto filter driver 624. Access to the hidden file will now be discussed with reference to FIG. 8(b).

Referring now to FIG. 8(b), a block diagram illustrating access to a hidden file after shield file information has been accessed according to an embodiment.

Crypto filter driver 624 may decrypt an encrypted link E_LINK received from shield file 210 as discussed previously. Crypto filter driver 624 may send link LINK to file system X 626. File system may access hidden metadata 222 from permanent storage X 640. File system X 626 may then return a file handle identifying data 224 of hidden file. This file handle may then be given to the requesting process and used in further accesses. In this way, once it has been identified that a user has proper permission to access protected data and a first access has been performed, subsequent accesses may be achieved by a requesting process without the step of accessing shield file 210. It should be noted that crypto filter driver 222 may execute encryption/decryption and/or scrambling/descrambling of data 224 of hidden file accordingly during all accesses.

As discussed above, when access to protected data is requested by an application program for the first time, crypto filter driver 222 may perform various tasks to identify the respective hidden file. Crypto filter driver 222 may request to file system (626 or 630) that a file system (626 or 630) access a hidden file to get a file handle. Crypto filter driver 222 may build a map table including a shield file name, file handle for a hidden file, respective crypto keys, scramble information and/or encryption information. Crypto filter driver 222 may return a file handle corresponding to a requested hidden file. Based on this map table, crypto filter driver 222 may perform data scramble/encryption for write access to permanent storage and a descramble/decryption for a read access from permanent storage. In this way, crypto filter driver 222 may serve as a proxy, terminating application file access requests, performing multiple operations with a file system, fetching file handles to hidden files, and returning file handles to hidden files to the requesting applications. All subsequent access to a protected file may go directly to a file system with a file handle for the hidden file. After such a file splicing is performed, crypto filter driver 222 may only be involved for data scramble/descramble and/or encryption/decryption operations.

When a user initially logs onto a network 100, use of user private key, user public key, etc. may be permitted with an expiration time. In this way, if a user is disconnected, protected data may be saved or work may be continued on protected data. Expiration time may vary depending on a security clearance of the user. For example, a company may wish to have low security clearance for a contract worker, such that any disconnection from network 100 may cause destruction of user public key, user private key, etc. However, a trusted employee may keep the ability to store and access stored protected information to and from permanent storage (640 and 650) in or connected to client device 130 in the same manner as described above.

Such a data protection method may be used to protect data from unauthorized storage to any permanent storage. Examples can include data client device connected to a company's computer system through a world-wide area network, such a client device may include personal computers, laptops, and a personal digital assistant (PDA). Other examples may include client devices connected to a corporate network, such as workstations, personal computers, and conventional back up devices, such as CD, DVD, floppy, tape, and zip drives, to name just a few examples.

Such a data protection method may provide protection for data copied or moved from corporate file servers. In this case, when such data is to be stored onto memory at a client device, it may pass through a crypto filter driver 624. If data is protected data, a shield file 210 and hidden files 220 may be created.

Once a data file is designated as protected, any derivative files may be designated as protected. For example, a file created using save as, cut and paste protected file information to another file, or appending a protected file to another file, to name just a few.

It is noted that by including a cypto filter driver 624 in a kernel space 620, or the like. Access to protected data, while restricted by received keys, may appear transparent to a user. That is, provided a user has valid keys, accesses to protected files may occur and/or appear no different than accesses to non-protected files.

A shield file may include owner information such as a user id/group id, owner IP address, domain name, etc, as just a few examples. By including such information, a client device may include protected files belonging to different owners. Also, files for different users may belong to the same owner or a different owner. Personal files and protected files may be included on a client device.

After user authentication is completed by a server, a client device may obtain owner information from the server. This information may be included in a corporate table in secure cache in kernal space accessible to a crypto filter driver on the client device. This information may not be transferred to permanent storage under any circumstances. A background thread initiated by crypto filter driver may “touch” a secured cache memory space regularly. In this way, a secured cache memory space may be made available in cache at all times and swapping of owner information to permanent storage may be prevented.

An owner may keep a protected file list for owner information management. The owner management functions may include, corporate owner information update, user private key refresh, recovery private key refresh, and corporate file shredding, as just a few examples. Such a protected file list may be included on the client device.

Owner file shredding on client device may be used to help free up permanent storage space on a client device and may be optionally controlled by the server.

User key and recovery keys may be refreshed under sever control. When a server makes a request for an update of a user private key, all protected files listed in a protected file list may be marked for user key update. If a file is marked for user key refresh, the recovery private key may be used on an encrypted recovery link to generate a link identifying a protected file. When a file is marked for recovery key update, a user private key may be used on an encrypted link to generate the link identifying the protected file. Either, a user private key or a recovery private key may always be up to date on all protected files. In this way, authorized access to a protected file may be assured.

When a protected file is copied from a client device to a network file system, the shield file may be removed. In this way, a hidden file in clear form may be copied.

When a protected file is copied from one client device to another client device, both shield and hidden files may be copied.

Data backup from network file servers to removable backup devices such as disks, tapes, CD, DVDs may be considered protected, as just a few examples.

Data scrambling may not be required for hidden files. An encrypted file system may provide data protection. The crypto filter driver may set on top of an encrypted file system.

Different scrambling options may be set as scrambling information in a shield file in accordance with policies. The scrambling technique used may be picked randomly at the time of file creation on the client device.

A server may set a policy option to prevent a copy of protected files onto storage devices external from the client device.

An access control server on, for example, a server controlled by an owner, may have dynamic control over owner information included on protected files on a client device. A server may request that a client device update owner information fields in a shield file.

It is understood that the embodiments described above are exemplary and the present invention should not be limited to those embodiments. Specific structures should not be limited to the described embodiments.

For example, although shield file 210 has been illustrated as a file that stores encrypted link, encrypted recovery link, etc as metadata, shield file 210 may include a shield metadata file and a shield data file. Shield metadata file may include metadata including pointers to shield data file. Shield data file may then include UserID, Server IP Address, encrypted link, encrypted recovery link, scramble time, or encryption information, etc, as actual data, to name just a few examples.

A hidden metadata file and a hidden data file may be conceptualized as a hidden file, such that one may essentially be an extension of the other.

Metadata and actual data may be included in one hidden file.

A client device may include a processing device and permanent storage devices coupled thereto, as just an example.

Thus, while the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A method of data protection, comprising the steps of:
receiving a first key;
receiving protected data; and
encrypting a link identifying a hidden file using the first key to generate a first encrypted link and storing the first encrypted link in a shield file.

2. The method of data protection according to claim 1, further including:
storing the first encrypted link in the shield file on a client device.

3. The method of data protection according to claim 2, wherein:
the client device is selected from a group consisting of a personal computer, a laptop computer, a workstation, an essentially permanent data backup device, and a personal digital assistant.

4. The method of data protection according to claim 3, wherein:
the shield file and the hidden file are stored on an essentially permanent storage device.

5. The method of data protection according to claim 1, further including the step of:
decrypting the first encrypted link to provide the link.

6. The method of data protection according to claim 1, wherein:
the first key is received from a network.

7. The method of data protection according to claim 1, further including the step of:
writing at least a portion of the protected data to the hidden file.

8. The method of data protection according to claim 7, further including the steps of:
receiving a second key;
decrypting the first encrypted link using the second key to provide the link; and
reading the at least a portion of the protected data from the hidden file.

9. The method of data protection according to claim 8, wherein:
the first key and the second key are received on a client device; and
the second key is not stored on an essentially permanent storage on the client device.

10. The method of data protection according to claim 7, further including the steps of:
receiving a first recovery key; and
encrypting the link identifying the hidden file using the first recovery key to generate a first encrypted recovery link and storing the first encrypted recovery link in the shield file.

11. The method of data protection according to claim 10, further including the steps of:
receiving a second recovery key;
decrypting the first encrypted recovery link using the second key to provide the link; and
reading the at least a portion of the protected data from the hidden file.

12. The method of data protection according to claim 7, wherein:
the shield file includes encryption data indicating a type of encryption of the at least a portion of the protected data in the hidden file.

13. The method of data protection according to claim 7, wherein:
the shield file includes scrambling data indicating a type of scrambling of the at least a portion of the protected data in the hidden file.

14. The method of data protection according to claim 1, wherein:
the shield file includes owner identifying data.

15. A method of protecting data received on a client device while coupled to a network through a communication channel, including the steps of:
receiving a first key at the client device;
receiving protected data at the client device;
encrypting a link identifying a hidden file using the first key to generate a first encrypted link and storing the first encrypted link in a shield file on an essentially permanent storage medium.

16. The method of protecting data according to claim 15, further including the step of:
writing at least a portion of the protected data to the hidden file on the essentially permanent storage medium.

17. The method of protecting data according to claim 16, wherein:
the hidden file may include a hidden metadata file and a hidden data file and at least one pointer to the hidden data file is included in the hidden metadata file; and
at least a portion of the protected data is written to the hidden data file on the essentially permanent storage medium.

18. The method of protecting data according to claim 17, further including the step of:
modifying the at least a portion of the protected data written to the hidden data file on the essentially permanent storage medium by using a technique from the group consisting of scrambling and encrypting.

19. The method of protecting data according to claim 16, further including the steps of:
receiving a second key at the client device;
decrypting the first encrypted link using the second key to provide the link; and
reading the at least a portion of the protected data from the hidden file.

20. The method of protecting data according to claim 19, wherein:
the first key and the second key are received on the client device from the network through the communication channel.

21. The method of protecting data according to claim 19, wherein:
the second key is not stored on the essentially permanent storage medium.

22. The method of protecting data according to claim 15, further including the step of:
generating the link using an essentially random number generator.

23. The method of protecting data according to claim 15, wherein:
the client device is selected from a group consisting of a personal computer, a laptop computer, a workstation, an essentially permanent data backup device, and a personal digital assistant.
